(19) United States
(12) Patent Application Publication
(10) Pub. No.: US 2020/0247315 A1
(43) Pub. Date: Aug. 6, 2020

(54) SPEED-DEPENDENT DARK-MODE FOR POLICE VEHICLES

(71) Applicant: Ford Global Technologies, LLC, Dearborn, MI (US)

(72) Inventors: Evangelos Foutis, Warren, MI (US); Erick Mogollon, Bloomfield Hills, MI (US); Thomas Lee Miller, Ann Arbor, MI (US)

(21) Appl. No.: 16/266,940

(22) Filed: Feb. 4, 2019

(51) Int. Cl. B60Q 3/80; H05B 37/02; B60W 40/105; B60Q 1/04

(52) U.S. Cl. CPC B60Q 3/80; H05B 37/0227; B60Q 3/40; B60W 40/105; B60Q 1/04; H05B 37/0218

(57) ABSTRACT

Method and apparatus are disclosed for speed-dependent dark-mode for police vehicles. An example vehicle includes a speed sensor for measuring a vehicle speed and a cabin. The cabin includes interior lamps and a dark-mode switch for activating a dark mode. The example vehicle also includes a controller that, when the dark mode is active, is configured to deactivate the interior lamps when the vehicle speed is less than a threshold and activate the interior lamps at a predetermined lowest luminance level when the vehicle speed is equal to or greater than the threshold.

### TECHNICAL FIELD

The present disclosure generally relates to police vehicles and, more specifically, to speed-dependent dark-mode for police vehicles.

### BACKGROUND

Generally, vehicles include headlamps to illuminate areas in front of the vehicles. Typically, a vehicle includes low-beam headlamps that are used in low-light conditions to illuminate a portion of a road along which the vehicle is travelling. A vehicle typically also includes tail lamps to that are used in low-light conditions to identify a location of the vehicle to other trailing vehicles. The headlamps and the tail lamps oftentimes are used to warn of a driving maneuver (e.g., braking, turning, etc.) being performed by the vehicle. Furthermore, a vehicle typically includes interior lamps (e.g., dome lamps, backlighting lamps, a display, etc.) within its cabin that are used by a vehicle operator (e.g., a driver) in low-light conditions to locate various objects (e.g., buttons, meters, displays, etc.) within the cabin of the vehicle.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for speed-dependent dark-mode for police vehicles. An example disclosed vehicle includes a speed sensor for measuring a vehicle speed and a cabin. The cabin includes interior lamps and a dark-mode switch for activating a dark mode. The example disclosed vehicle also includes a controller that, when the dark mode is active, is configured to deactivate the interior lamps when the vehicle speed is less than a threshold and activate the interior lamps at a predetermined lowest luminance level when the vehicle speed is equal to or greater than the threshold.

In some examples, the dark mode of the interior lamps is configured to facilitate the vehicle in being unobserved by a passerby in low-light conditions. In some examples, the interior lamps include at least one of a display, a dome lamp, and a backlighting lamp for an instrument cluster. In some examples, the predetermined lowest luminance level has a luminous intensity value greater than zero. In some examples, the dark-mode switch is located on a dashboard or center console.

Some examples include an ambient light sensor to measure an ambient light level. In some such examples, when the dark mode is inactive, the controller is configured to select an emitted luminance level for the interior lamps based on the ambient light level. In some such examples, the emitted luminance level selected by the controller is one of a plurality of predefined luminance levels. In some such examples, the plurality of predefined luminance levels includes daytime luminance levels and nighttime luminance levels. In some such examples, each of the daytime luminance levels is greater than each of the nighttime luminance levels. Further, in some such examples, wherein the predetermined lowest luminance level utilized for the dark mode is a lowest one of the nighttime luminance levels.

Some examples further include exterior lamps a headlight switch located within the cabin for the exterior lamps. In some such examples, the exterior lamps include at least one of headlamps and tail lamps. In some such examples, the controller is configured to deactivate the exterior lamps when the headlight switch is in an off-position. In some such examples, the controller is configured to select a luminance level at which the exterior lamps are to emit light based on an ambient light level. In some such examples, the controller is to emit an alert responsive to determining that the dark mode is active and the vehicle speed has been equal to or greater than the threshold for a predetermined duration.

An example disclosed method for a vehicle includes measuring a vehicle speed via a speed sensor. The example disclosed method also includes, responsive to determining that a dark mode is activated via dark-mode switch within a cabin, deactivating, via a processor, interior lamps within the cabin when the vehicle speed is less than a threshold and activating, via the processor, the interior lamps at a predetermined lowest luminance level when the vehicle speed is equal to or greater than the threshold.

Some examples include measuring an ambient light level via an ambient light sensor. Some examples further include, when the dark mode is inactive, emitting light via the interior lamps at a luminance level selected based on the ambient light level. Some examples include emitting an alert responsive to determining that the dark mode is active and the vehicle speed has been equal to or greater than the threshold for a predetermined duration.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an exterior of an example vehicle in accordance with the teachings herein.

FIG. 2 illustrates an interior cabin of vehicle of FIG. 1.

FIG. 3 depicts an example environment in which the vehicle of FIG. 1 utilizes dark-mode.

FIG. 4 is a block diagram of electronic components of the vehicle of FIG. 1.

FIG. 5 is an example flowchart for operating dark-mode of a vehicle in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Generally, vehicles include headlamps to illuminate areas in front of the vehicles. Typically, a vehicle includes low-beam headlamps that are used in low-light conditions to illuminate a portion of a road along which the vehicle is travelling. A vehicle typically also includes tail lamps to that are used in low-light conditions to identify a location of the vehicle to other trailing vehicles. The headlamps and the tail lamps oftentimes are used to warn of a driving maneuver (e.g., braking, turning, etc.) being performed by the vehicle. Furthermore, a vehicle typically includes interior lamps (e.g., dome lamps, backlighting lamps, a display, etc.) within its cabin that are used by a vehicle operator (e.g., a driver) in low-light conditions to locate various objects (e.g., buttons, meters, displays, etc.) within the cabin of the vehicle.

Oftentimes, a police vehicle (sometimes referred to as a squad car) may be positioned along a side of a road and/or another location for surveillance purposes. For instance, the police vehicle may be located along the side of the road for a stakeout, identification of speeding vehicles, and/or other surveillance purposes. In some instances, a police officer operating a police vehicle for surveillance purposes may elect turn off the headlamps, tail lamps, and/or other exterior lamps of the police vehicle to help the police vehicle remain hidden to passersby and/or other nearby people. In such instances, any interior lighting that is active within the police vehicle may undesirably enable passersby and/or other people nearby to see the police vehicle.

Examples methods and apparatus disclosed herein include a dark mode for cabin lighting of a police vehicle and/or another vehicle in low-light conditions. The police vehicle includes a dark-mode switch within its cabin to enable an operator (e.g., a driver, a police officer, etc.) activate and/or deactivate the dark mode of the cabin lighting. As used herein, “dark mode,” “dark-mode,” and “police-dark mode” refer to a mode of a vehicle (e.g., a police vehicle) during which lights within a cabin of the vehicle are deactivated and/or set to a lowest-active luminance level while the vehicle is activated in low-light conditions to deter the vehicle from being observed by passersby and/or other nearby people. As used herein, “luminance” refers to an amount of luminous intensity per unit area of light travelling in a particular direction. As used herein, “luminous intensity” refers to an amount of power emitted by a light source in a particular direction. As used herein, “brightness” refers to a characteristic of light radiated or reflected from a light source as visually-perceived by an observer.

In examples disclosed herein, when the dark mode is active and the police vehicle is travelling at a speed below a predetermined speed threshold (e.g., 15 miles per hour), a controller of the police vehicle turns off the cabin lighting to facilitate the vehicle in being unobserved by passersby and/or other people nearby in low-light conditions. When the dark mode is active and the police vehicle is travelling at a speed equal to or greater than the predetermined speed threshold, the controller of the police vehicle turns on the cabin lighting the police-dark system activates the interior lights to a predetermined lowest-active luminance level to (1) continue to facilitate the vehicle in being unobserved by passersby and/or other people in low-light conditions and (2) facilitate the operator in locating objects within the cabin of the vehicle (e.g., to facilitate the operator in locating the dark-mode switch for turning off the dark mode).

For instance, to surveil a particular area of interest without being seen, a police officer may turn off the exterior lamps of the police vehicle and activate dark mode for the interior lamps of the police vehicle. While the police vehicle remains stationary, the cabin lighting is turned off in the dark mode to deter the police vehicle from being seen by passersby and/or other people in low-light conditions. When the police officer observes activity-of-interest, the police officer may begin to drive the vehicle toward the activity-of-interest. While initially driving toward the activity-of-interest, the cabin lighting remains turned off in the dark mode to keep the police vehicle from being seen. When the speed of the police vehicle increases to a predefined threshold, the interior lights are activated to the predetermined lowest-active luminance level in the dark mode. The dark mode utilizes the predetermined lowest-active luminance level when the police vehicle is travelling at increased speeds to enable the operator to locate the dark-mode switch to eventually turn off the dark mode while continuing to facilitate the vehicle in being unobserved by passersby and/or other people nearby.

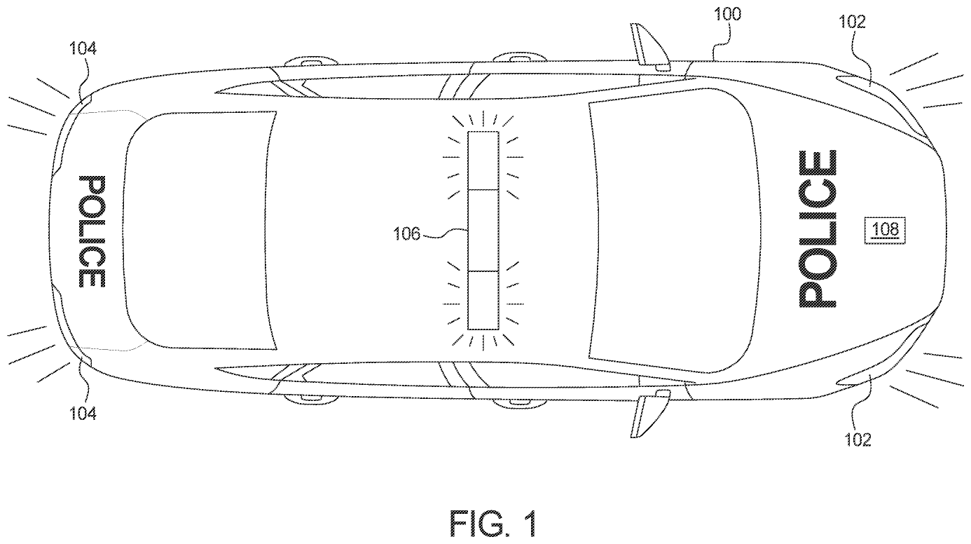

Turning to the figures, FIG. 1 illustrates an example vehicle 100 in accordance with the teachings herein. In the illustrated example, the vehicle 100 is a police vehicle. In other examples, the vehicle 100 is a fire truck (sometimes referred to as a fire engine), an ambulance, another emergency vehicle type, and/or any other type of vehicle. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input).

The vehicle 100 of the illustrated example includes headlamps 102 located at a front of the vehicle 100 and tail lamps 104 located at a rear of the vehicle 100. When activated, the headlamps 102 emit headlights that illuminate a portion of a road in front of the vehicle 100 to enable a vehicle operator (e.g., a driver) to see in front of the vehicle 100 in low-light conditions (e.g., nighttime). In some examples, each of the headlamps 102 includes (i) a low-beam headlamp to illuminate a side of a road along which the vehicle 100 is travelling and (ii) a high-beam headlamp to illuminate a greater portion of the road. Further, the tail lamps 104 are activated to warn others when the vehicle 100 is braking, turning, etc. Additionally or alternatively, the headlamps 102 and tail lamps 104 are activated to facilitate another vehicle (e.g., a trailing vehicle, an oncoming vehicle, etc.) to view the vehicle 100 in low-light conditions.

In the illustrated example, the vehicle 100 is a police vehicle that includes a light bar 106. As illustrated in FIG. 1, the light bar 106 is located on a roof of the vehicle 100. The light bar 106 includes a plurality of lamps (e.g., colored lamps) to emit emergency light signals (e.g., strobe lighting, rotating lighting, alternating lighting, etc.). Additionally or alternatively, the vehicle 100 includes other emergency lighting at different locations on the vehicle 100.

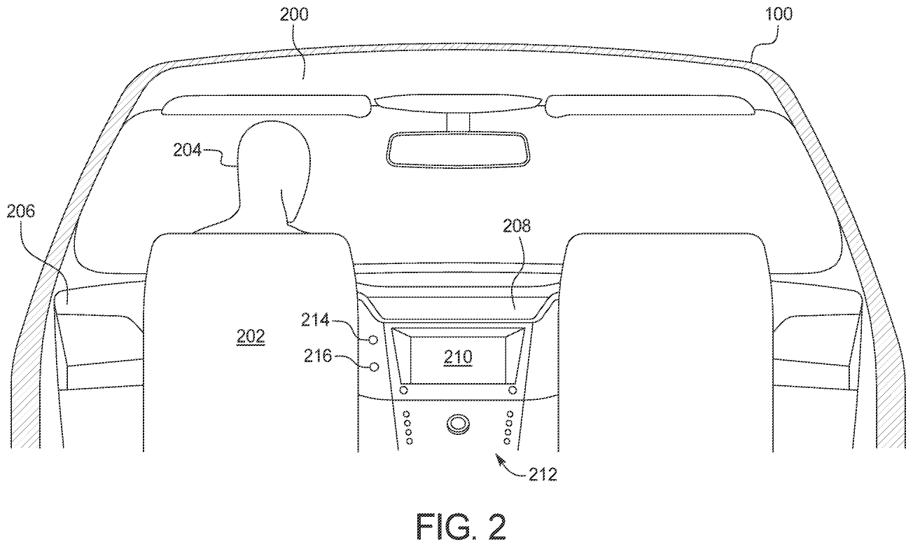

The vehicle 100 of the illustrated example also includes a lighting controller 108. For example, the lighting controller 108 is configured to control lighting of the vehicle 100. For example, the lighting controller 108 controls exterior lamps of the vehicle 100, such as the headlamps 102, the tail lamps 104, and the lamps of the light bar 106. Further, the lighting controller 108 of the illustrated example controls interior lamps within a cabin of the vehicle 100 (e.g., a cabin 200 of FIG. 2) to control cabin lighting of vehicle 100. For example, the lighting controller 108 controls the interior lamps when dark mode of the vehicle 100 is active and/or inactive.

FIG. 2 illustrates a cabin 200 of vehicle 100. As illustrated in FIG. 2, a seat 202 for an operator 204 (e.g., a driver, a police officer, etc.) of the vehicle 100 is located in the cabin 200. Further, a dashboard 206, a center console 208, and/or other control panel(s) are located in the cabin 200 of the vehicle 100.

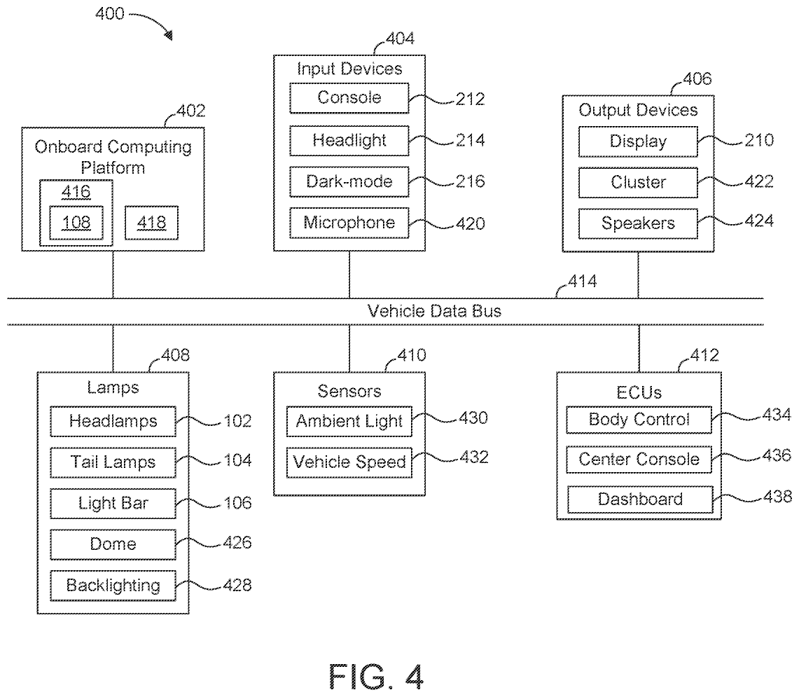

In the illustrated example, the dashboard 206 is located directly in front of the seat 202 for the operator 204. The dashboard 206 includes output and/or input device(s) to facilitate the operator 204 in operating the vehicle 100. For example, the dashboard 206 includes a cluster of instrument outputs (e.g., instrument cluster outputs 422 of FIG. 4), such as dials, meters, etc., to enable the operator 204 to monitor various characteristics of the vehicle 100 while operating the vehicle 100. Additionally or alternatively, the dashboard 206 includes input device(s), such as switches, buttons, etc., to enable the operator 204 to control various features of the vehicle 100 while operating the vehicle 100. Further, in some examples, the dashboard 206 includes backlighting lamps that are configured to illuminate the output and/or input device(s) of the dashboard 206 in low-light conditions.

The center console 208 of the illustrated example is centrally located along a front of the cabin 200 of the vehicle 100. For example, the center console 208 is located adjacent to the dashboard 206 between the seat 202 for the operator 204 (e.g., the driver seat) and a front, passenger seat. The center console 208 also includes output and/or input device(s) to facilitate the operator 204 in operating the vehicle 100. For example, the center console 208 includes a display 210 and console input devices 212. The console input devices 212 include input device(s), such as switches, buttons, etc., to enable the operator 204 and/or a passenger to control various features of the vehicle 100. In some examples, the center console 208 includes backlighting lamps that are configured to illuminate the console input devices 212 and/or output device(s) of the center console 208 in low-light conditions. Further, the display 210 (also referred to as a center console display) includes a liquid crystal display (LCD), an organic light emitting diode (OLED) display, a flat panel display, a solid state display, and/or another type of display. In some examples, the display 210 is a touchscreen. Additionally or alternatively, the display 210 is configured to present an infotainment system of the vehicle 100 (such as SYNC® and MyFord Touch® by Ford®).

In the illustrated example, the vehicle 100 includes a headlight switch 214 and a dark-mode switch 216. Each of the headlight switch 214 and the dark-mode switch 216 is a pushbutton, a toggle switch, a rotary switch, a rocker switch, and/or any other type of switch that is configured to receive an input from the operator 204. In the illustrated example, the headlight switch 214 and the dark-mode switch 216 are located on and/or adjacent to the dashboard 206 and/or the center console 208. In other examples, the headlight switch 214 and/or the dark-mode switch 216 may be positioned at any other location within the cabin 200 that the operator 204 may reach easily while seated in the seat 202.

The headlight switch 214 of the illustrated example is configured to enable the operator 204 to control activation of the headlamps 102, the tail lamps 104, and/or other exterior lamps of the vehicle 100 for low-light conditions. For example, when the operator 204 positions the headlight switch 214 in the off-position, the lighting controller 108 causes the headlamps 102 and/or other exterior lamps to not emit headlights. When the operator 204 positions the headlight switch 214 in the on-position, the lighting controller 108 causes the headlamps 102 and/or other exterior lamps to emit the headlights at a preset luminance level. Further, when the operator 204 positions the headlight switch 214 in the automatic position, the lighting controller 108 causes the headlamps 102 and/or other exterior lamps to emit the headlights at a luminance level based on a measured ambient light level of the vehicle 100 (e.g., measured by one or more ambient light sensors 430 of FIG. 4). That is, when the headlight switch 214 is in the automatic position, the lighting controller 108 is configured to select a luminance level at which the headlamps 102 and/or other exterior lamps emit light based on a measured ambient light level. For example, the lighting controller 108 causes the headlamps 102 and/or other exterior lamps to emit the headlights at a preset luminance level when a low ambient light level is detected, and the lighting controller 108 causes the headlamps 102 and/or other exterior lamps to not emit the headlights when a high ambient light level is detected.

The dark-mode switch 216 (also referred to as a dimmer switch) is configured to enable the operator 204 to activate and/or deactivate a dark mode of interior lighting within the cabin 200 of the vehicle 100. For example, interior lamps that emit the interior lighting include lamps of the display 210, backlighting lamps (e.g., backlighting lamps 428 of FIG. 4), a dome lamp (e.g., a dome lamp 426 of FIG. 4) and/or other lamp(s) positioned within the cabin 200 of the vehicle 100. In some examples, the interior lamps include a plurality of light-emitting diodes (LEDs). The LEDs may be fully illuminated, fully dimmed, and/or partially illuminated to produce a plurality of luminance level settings the interior lighting of for the vehicle 100. In the illustrated example, the dark-mode switch 216 includes an on-position and an off-position. The dark mode of the vehicle is active when the dark-mode switch 216 is in the on-position, and the dark mode of the vehicle is inactive when the dark-mode switch 216 is in the off-position.

When the dark mode is inactive, the lighting controller 108 is configured to cause the interior lamps to emit light based on the measured ambient light levels within the cabin 200 of the vehicle 100. For example, the lighting controller 108 is configured to select one of a plurality of predefined luminance levels for the interior lighting based on the measured ambient light level. In some examples, the predefined luminance levels include a plurality of predefined daytime luminance levels (e.g., fourteen daytime levels) and a plurality of predefined nighttime luminance levels (e.g., six daytime levels). Each of the daytime luminance levels is greater than each of nighttime luminance levels. That is, less luminance is required for lighting to appear bright in low-light conditions (e.g., nighttime) relative to high-light conditions). In turn, the lighting controller 108 (i) reduces the luminance of the interior lighting as the ambient light transitions from high-light conditions to low-light conditions and/or (ii) increases the luminance of the interior lighting as the ambient light transitions from low-light conditions to high-light conditions.

Further, when the dark mode is active, the lighting controller 108 is configured to deactivate the interior lamps when a speed of the vehicle 100 (e.g., as measured by a vehicle speed sensor 432 of FIG. 4) is less than a predetermined speed threshold (e.g., 15 miles per hour). That is, the when the dark mode is active, the lighting controller 108 turns off the interior lighting within the cabin 200 of the vehicle 100 to facilitate the vehicle 100 in being unobserved by passersby in low-light conditions. For example, the interior lighting has a luminance intensity of zero and/or substantially zero (e.g., indiscernible to the human eye) when the interior lamps are turned off. Additionally, when the dark mode is active, the lighting controller 108 is configured to activate the interior lamps at a predetermined lowest luminance level (e.g., a lowest of the nighttime luminance levels) when the speed of the vehicle 100 is greater than or equal to the predetermined speed threshold to also facilitate the vehicle 100 in being unobserved by passersby in low-light conditions.

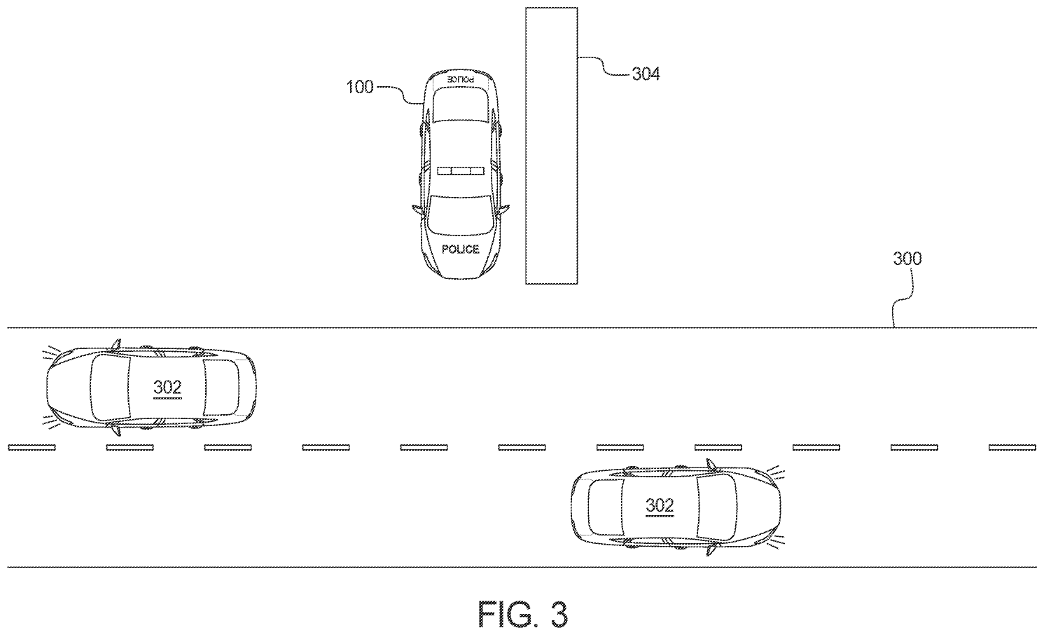

FIG. 3 depicts an example environment in which dark mode is active for the vehicle 100. In the illustrated example, the vehicle 100 is parked along a road 300 to enable the operator 204 of the vehicle 100 to monitor an adjacent portion of the road 300 r example, the vehicle 100 is parked along a side of the road 300 to enable the operator 204 to monitor other vehicles 302 travelling along the road 300. Further, in the illustrated example, the vehicle 100 is located next to an object 304 that hides the vehicle 100 from operators of the vehicles 302. For example, the object 304 may be a wall, a fence, a post, a tree, and/or any other object that facilitates the vehicle 100 in being unobserved by passersby. In low-light conditions, the dark mode of the vehicle 100 is activated and the exterior lamps (e.g., the headlamps 102, the tail lamps 104) are turned off to further facilitate the vehicle 100 in being unobserved by passersby. When the dark mode is active, the lighting controller 108 deactivates the interior lamps when the vehicle 100 is stationary.

In operation, the vehicle 100 may remain stationary along the side of the road 300 until to the operator 204 of the vehicle 100 observes an activity-of-interest (e.g., one of the vehicles 302 is speeding). In turn, the operator 204 may cause the vehicle 100 to travel toward the activity-of-interest. The lighting controller 108 keeps the interior lamps deactivated until the vehicle speed of the vehicle 100 reaches a predetermined speed threshold (e.g., 15 miles per hour) to continue to facilitate the vehicle 100 in being unobserved. Once the vehicle speed of the vehicle 100 reaches the predetermined speed threshold, the lighting controller 118 activates the interior lamps at a predetermined lowest luminance level (e.g., a lowest of the nighttime luminance levels) to (i) continue to facilitate the vehicle 100 in being unobserved by passersby and (ii) facilitate the operator 204 to locate the dark-mode switch 216, the headlight switch 214, and/or any other devices within the cabin 200 of the vehicle 100. The lighting controller 118 activates the interior lamps of the vehicle 100 at a luminance level determined based on the ambient light level once the operator actuates the dark-mode switch 216 to the off-position. Further, the lighting controller 118 activates the exterior lamps of the vehicle 100 once the operator actuates the headlight switch 214 to the on-position and/or the automatic position. In some examples, the lighting controller 118 is configured to emit an alert (e.g., an audio alert, a visual alert) within the cabin 200 of the vehicle 100 in response to determining that the vehicle speed has equaled or exceeded the predetermined speed threshold for at least a predetermined duration while the dark mode is active and/or the exterior lights are off to remind the operator 204 to eventually turn on the interior lighting and/or the exterior lighting while travelling toward the activity-of-interest.

Further, in some examples, the dark mode of the vehicle 100 deactivates one or more audio features of the vehicle 100. For example, an infotainment system of the vehicle 100 (such as SYNC® and MyFord Touch® by Ford®) may communicatively couple to a mobile device of the operator 204 to perform telephone calls associated with the mobile device. In such instances, the operator utilizes speaker(s) and microphone(s) within the cabin 200 of the vehicle 100 to perform the telephone call. In some examples, the dark mode prevents incoming phone calls from being performed via the speaker(s) and microphone(s) within the cabin 200 to deter the vehicle 100 from being audibly detected as a result of the infotainment system performing the incoming phone call. In some such examples, any incoming phone call is sent directly to voice message. Further, in some examples, the dark mode prevents the infotainment system from reading out loud any incoming text messages, emails, etc. Additionally or alternatively, when the vehicle 100 is in the dark mode, the lighting controller 118 enables the infotainment system to perform outgoing calls for the vehicle 100.

FIG. 4 is a block diagram of electronic components 400 of the vehicle 100. In the illustrated example, the electronic components 400 includes an onboard computing platform 402, input devices 404, output devices 406, lamps 408, sensors 410, electronic control units (ECUs) 412, and a vehicle data bus 414.

The onboard computing platform 402 includes a processor 416 (also referred to as a microcontroller unit and a controller) and memory 418. In the illustrated example, the processor 416 of the onboard computing platform 402 is structured to include the lighting controller 108. In other examples, the lighting controller 108 is incorporated into another ECU with its own processor and memory. The processor 416 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 418 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 418 includes multiple kinds of memory, particularly volatile memory and non-volatile memory.

The memory 418 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 418, the computer readable medium, and/or within the processor 416 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The input devices 404 provide interface(s) between the vehicle 100 and user(s) (e.g., the operator 204) to collect input information from the user(s). The input devices 404 may include digital interface(s) and/or analog interface(s) located on the dashboard 206, the center console 208, another control panel, and/or any other position within the cabin 200 of the vehicle 100. For example, the input devices 404 include control knob(s), button(s), switch(es), instrument panel(s), digital camera(s) for image capture and/or visual command recognition, touchscreen(s) (e.g., the display 210, touchpad(s). In the illustrated example, the input devices 404 include the console input devices 212, the headlight switch 214, the dark-mode switch 216, and a microphone 420. For example, the microphone 420 is located within the cabin 200 of the vehicle 100 to collect audio signals including voice commands from the operator 204 of the vehicle 100.

The output devices 406 also provide interface(s) between the vehicle 100 and its user(s) (e.g., the operator 204) to provide output information to the user(s). The output devices 406 may include digital interface(s) and/or analog interface(s) located on the dashboard 206, the center console 208, another control panel, and/or any other position within the cabin 200 of the vehicle 100. For example, the output devices 406 include the display 210 of the center console 208, other display(s) (e.g., a heads-up display), instrument cluster outputs 422 (e.g., dials, meters, etc.), speakers 424, etc.

The lamps 408 of the illustrated example emit light within and/or outside of the cabin 200 of the vehicle 100. For example, the lamps 408 include the lamps 408 include exterior lamps that are configured to emit from outside the cabin 200 of the vehicle 100 to enable the operator 204 to see in low-light conditions and/or to alert operator(s) of other vehicle(s) to the movement of the vehicle 100. Example exterior lamps include the headlamps 102, the tail lamps 104, and lamps of the light bar 106.

The lamps 408 of the illustrated example also include interior lamps that are configured to emit from within the cabin 200 of the vehicle 100. Example interior lamps include a dome lamp 426, backlighting lamps 428, and the lamps of the display 210. For example, the dome lamp 426 is located toward a top of the cabin 200 and facilitates the operator 204 in viewing object(s) within the cabin 200 in low-light conditions. The backlighting lamps 428 provide backlighting to one or more of the output devices 406 to facilitate the operator 204 in viewing those of the output devices 406 in low-light conditions.

The sensors 410 are arranged in and/or around the vehicle 100 to monitor properties of the vehicle 100 and/or an environment in which the vehicle 100 is located. One or more of the sensors 410 may be mounted to measure properties around an exterior of the vehicle 100. Additionally or alternatively, one or more of the sensors 410 may be mounted inside a cabin of the vehicle 100 or in a body of the vehicle 100 (e.g., an engine compartment, wheel wells, etc.) to measure properties in an interior of the vehicle 100. For example, the sensors 410 include accelerometers, odometers, tachometers, pitch and yaw sensors, wheel speed sensors, microphones, tire pressure sensors, biometric sensors and/or sensors of any other suitable type.

In the illustrated example, the sensors 410 include one or more ambient light sensors 430 and a vehicle speed sensor 432. The ambient light sensors 430 measure ambient light levels within the cabin 200 of the vehicle 100 and/or of a surrounding area of the vehicle 100. For example, the ambient light sensors 430 measure light intensities of collected light beams to determine ambient light levels. In some examples, one or more of the ambient light sensors 430 is located within the cabin 200 of the vehicle 100 to measure an ambient light level within the cabin 200. Additionally or alternatively, one or more of the ambient light sensors 430 is located along an exterior of the vehicle 100 measure an ambient light level outside of a surrounding area of the vehicle 100. Further, the vehicle speed sensor 432 measures a speed at which the vehicle 100 is traveling. In some examples, the vehicle speed sensor 432 is utilized to determine an acceleration and/or deceleration of the vehicle 100.

The ECUs 412 monitor and control the subsystems of the vehicle 100. For example, the ECUs 412 are discrete sets of electronics that include their own circuit(s) (e.g., integrated circuits, microprocessors, memory, storage, etc.) and firmware, sensors, actuators, and/or mounting hardware. The ECUs 412 communicate and exchange information via a vehicle data bus (e.g., the vehicle data bus 414). Additionally, the ECUs 412 may communicate properties (e.g., status of the ECUs 412, sensor readings, control state, error and diagnostic codes, etc.) to and/or receive requests from each other. For example, the vehicle 100 may have dozens of the ECUs 412 that are positioned in various locations around the vehicle 100 and are communicatively coupled by the vehicle data bus 414.

In the illustrated example, the ECUs 412 include a body control module 434, a center console module 436, and a dashboard module 438. The body control module 434 controls one or more subsystems throughout the vehicle 100, such as power windows, power locks, an immobilizer system, power mirrors, etc. For example, the body control module 434 includes circuits that drive one or more of relays (e.g., to control wiper fluid, etc.), brushed direct current (DC) motors (e.g., to control power seats, power locks, power windows, wipers, etc.), stepper motors, LEDs, etc. The center console module 436 controls one or more subsystems to operate the input devices 404 (e.g., the console input devices 212) and/or the output devices 406 (e.g., the display 210) of the center console 208. The dashboard module 438 controls one or more subsystems to operate the input devices 404 (e.g., the headlight switch 214, the dark-mode switch 216) and/or the output devices 406 (e.g., the instrument cluster outputs 422) of the dashboard 206.

The vehicle data bus 414 communicatively couples the onboard computing platform 402, the input devices 404, the output devices 406, the lamps 408, the sensors 410, and the ECUs 412. In some examples, the vehicle data bus 414 includes one or more data buses. The vehicle data bus 414 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

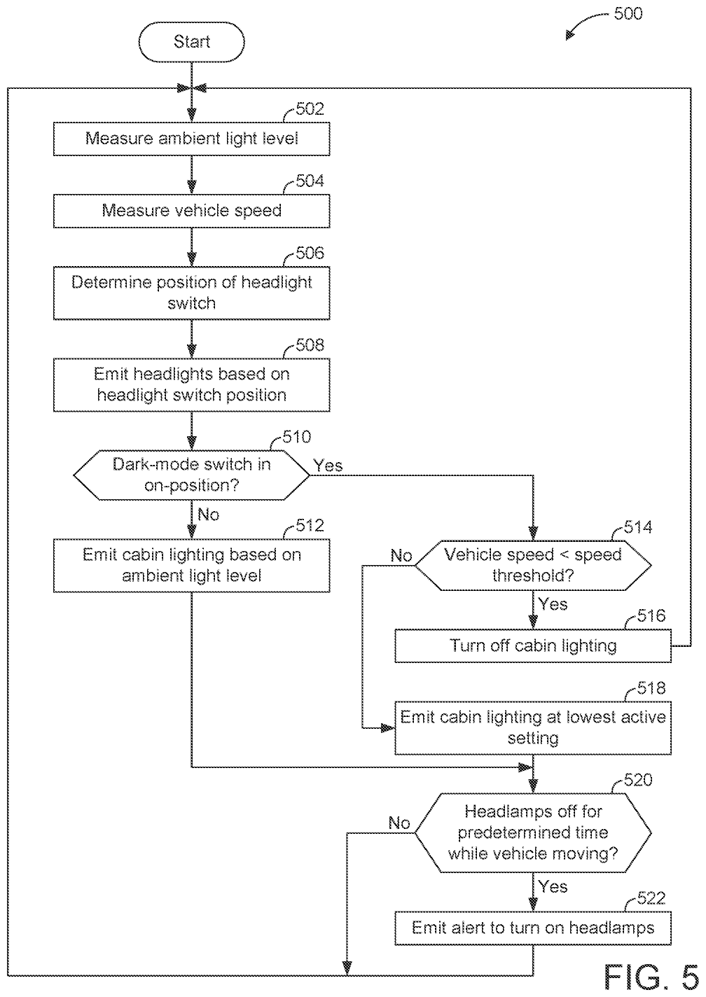

FIG. 5 is a flowchart of an example method 500 to operate dark-mode of a vehicle. The flowchart of FIG. 5 is representative of machine readable instructions that are stored in memory (such as the memory 418 of FIG. 4) and include one or more programs which, when executed by a processor (such as the processor 416 of FIG. 4), cause the vehicle 100 to implement the example lighting controller 108 of FIGS. 1 and 4. While the example program is described with reference to the flowchart illustrated in FIG. 5, many other methods of implementing the example lighting controller 108 may alternatively be used. For example, the order of execution of the blocks may be rearranged, changed, eliminated, and/or combined to perform the method 500. Further, because the method 500 is disclosed in connection with the components of FIGS. 1-4, some functions of those components will not be described in detail below.

Initially, at block 502, one or more of the ambient light sensors 430 measure ambient light levels. For example, one or more of the ambient light sensors 430 measure an ambient light level outside of the vehicle 100, and one or more of the ambient light sensors 430 measure an ambient light level within the cabin 200 of the vehicle 100. Further, the lighting controller 108 collects the ambient light level measurements from the ambient light sensors 430. At block 504, the vehicle speed sensor 432 measures a vehicle speed of the vehicle 100. Further, the lighting controller 108 collects the vehicle speed measurement from the vehicle speed sensor 432.

At block 506, the lighting controller 108 determines a position of the headlight switch 214. For example, the lighting controller 108 detects whether the headlight switch 214 is in an off-position, an on-position, or an automatic position. At block 508, the headlamps 102 emit headlights based on the position of the headlight switch 214. For example, the lighting controller 108 causes the headlamps 102 to (i) not emit headlights in response to determining the headlight switch 214 is in the off-position, (ii) emit the headlights at a preset luminance level in response to determining the headlight switch 214 is in the on-position, or (iii) emit the headlights at a luminance level based on the measured ambient light level in response to determining that the headlight switch 214 is in the automatic position.

At block 510, the lighting controller 108 determines whether the dark-mode switch 216 is in an on-position. In response to the lighting controller 108 determining that the dark-mode switch 216 is not in the on-position (i.e., the dark-mode switch 216 is in an off-position), the method 500 proceeds to block 512 at which the lighting controller 108 sets the interior lamps within the cabin 200 of the vehicle 100 in dark mode. In the dark mode, the lighting controller 108 causes the interior lamps within the cabin 200 to emit cabin lighting at a luminance level based on the measured ambient light level. For example, in response to determining that the ambient light level corresponds with daytime, the lighting controller 108 causes the interior lamps to emit light at a predefined daytime luminance level. Further, in response to determining that the ambient light level corresponds with nighttime and/or other low-light conditions, the lighting controller 108 causes the interior lamps to emit light at a predefined nighttime luminance level. Upon completing block 512, the method 500 proceeds to block 520.

Returning to block 510, in response to the lighting controller 108 determining that the dark-mode switch 216 is in the on-position, the method proceeds to block 514 at which the lighting controller 108 compares the measured vehicle speed to a predetermined speed threshold (e.g., 15 miles per hour). In response to the lighting controller 108 determining that the vehicle speed is less than the predetermined speed threshold, the method 500 proceeds to block 516 at which the lighting controller 108 deactivates the interior lamps within the cabin 200 to turn off the cabin lighting. That is, the lighting controller 108 causes the interior lamps to have a luminance intensity value of zero and/or substantially zero. Upon completing block 516, the method 500 proceeds to returns 502.

Returning to block 514, in response to the lighting controller 108 determining that the vehicle speed is not less than (i.e., is greater than or equal to) the predetermined speed threshold, the method 500 proceeds to block 518 at which the lighting controller 108 causes the interior lamps within the cabin 200 to emit the cabin lighting at a predetermined lowest luminance level (e.g., a lower luminance level having a luminance intensity greater than zero). For example, the lighting controller 108 causes the interior lamps to emit the cabin lighting at the predetermined lowest luminance level while dark mode is active and the vehicle 100 is travelling at speed greater than the predetermined speed threshold to simultaneously facilitate (1) the vehicle 100 in being unobserved by passersby and/or other people in low-light conditions and (2) the operator 204 in locating objects (e.g., the display 210, the headlight switch 214, the dark-mode switch 216, etc.) within the cabin 200 of the vehicle 100. Upon completing block 516, the method 500 proceeds to block 520.

At block 520, the lighting controller 108 determines whether the headlamps 102 have been off for a predetermined period of time while the vehicle 100 has been moving in low-light conditions. In response to the lighting controller 108 determining that the headlamps 102 have not been off under such conditions, the method 500 returns to block 502. Otherwise, in response to the lighting controller 108 determining that the headlamps 102 have been off under such conditions, the method 500 proceeds to block 522 at which the lighting controller 108 emits an alert (e.g., an audio alert, a visual alert) within the cabin 200 of the vehicle 100 to remind the operator 204 to turn on the headlamps 102.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively. Additionally, as used herein, “module” refers to hardware with circuitry to provide communication, control and/or monitoring capabilities. A “module” may also include firmware that executes on the circuitry.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

1. A vehicle comprising:
a computer processor operable to execute a set of computer-readable instructions; and
a memory operable to store the set of computer-readable instructions operable to:
determine that a dark mode of the vehicle has been initiated;
dim or deactivate, based on the dark mode being initiated, an interior lamp of the vehicle;
determine that a speed of the vehicle is greater than or equal to a threshold speed; and
increase a luminance of or activate the interior lamp based on the speed of the vehicle being greater than or equal to the threshold speed.

2. The vehicle of claim 1, further comprising a headlight switch, wherein the headlight switch comprises an on position for turning on a headlamp of the vehicle, an off position for turning off the headlamp of the vehicle, and an automatic position for allowing the headlamp to automatically be set to a luminance level based on an ambient light level, and further wherein the dark mode of the interior lamps is configured to facilitate the vehicle in being unobserved by a passerby in low-light conditions.

3. The vehicle of claim 1, wherein the interior lamps include at least one of a display, a dome lamp, and a backlighting lamp for an instrument cluster.

4. The vehicle of claim 1, wherein the luminance is increased to a predetermined lowest luminance level, and wherein the predetermined lowest luminance level has a luminous intensity value that is selected to allow an operator of the vehicle to locate at least one of a headlight switch or a dark-mode switch in the vehicle.

5. The vehicle of claim 1, further comprising a dark-mode switch, wherein the dark-mode switch is located on a dashboard or center console.

6. The vehicle of claim 4, further including an ambient light sensor to measure an ambient light level.

7. The vehicle of claim 6, wherein the computer-readable instructions are further operable to:
when the dark mode is inactive, select an emitted luminance level for the interior lamps based on the ambient light level.

8. The vehicle of claim 7, wherein the emitted luminance level is one of a plurality of predefined luminance levels.

9. The vehicle of claim 8, wherein the plurality of predefined luminance levels includes daytime luminance levels and nighttime luminance levels.

10. The vehicle of claim 9, wherein each of the daytime luminance levels is greater than each of the nighttime luminance levels.

11. The vehicle of claim 10, wherein the predetermined lowest luminance level utilized for the dark mode is a lowest one of the nighttime luminance levels.

12. (canceled)

13. The vehicle of claim 1, further comprising a headlight switch for activating an exterior lamp of the vehicle, and wherein the exterior lamp includes headlamps and tail lamps of the vehicle.

14. (canceled)

15. The vehicle of claim 1, wherein the computer-readable instructions are further operable to select a luminance level at which an exterior lamp is to emit light based on an ambient light level.

16. The vehicle of claim 13, wherein the computer-readable instructions are further operable to emit an alert responsive to determining that the dark mode is active and the vehicle speed has been equal to or greater than the threshold for a predetermined duration, to remind an operator of the vehicle to turn on the headlamps.

17. A method for a vehicle comprising:
activating a headlight switch to turn off headlamps of the vehicle;
measuring a vehicle speed via a speed sensor; and
responsive to determining that a dark mode is activated via a dark-mode switch within a cabin:
deactivating, via a processor, interior lamps within the cabin when the vehicle speed is less than a threshold; and
activating, via the processor, the interior lamps at a predetermined lowest luminance level when the vehicle speed is equal to or greater than the threshold.

18. The method of claim 17, further including measuring an ambient light level via an ambient light sensor.

19. The method of claim 18 further including, when the dark mode is inactive, emitting light via the interior lamps at a luminance level selected based on the ambient light level.

20. The method of claim 17, further including emitting an alert responsive to determining that:
the dark mode is active; and
the vehicle speed has been equal to or greater than the threshold for a predetermined duration.
